(19) United States
(12) Patent Application Publication
(10) Pub. No.: US 2012/0006160 A1
(43) Pub. Date: Jan. 12, 2012

(54) REPLACEABLE SCREW-FASTENING ASSEMBLY

(76) Inventor: Tzu-Chien WANG, Tainan City (TW)

(21) Appl. No.: 12/834,495

(22) Filed: Jul. 12, 2010

(51) Int. Cl. B25B 23/10

(52) U.S. Cl. 81/438; 81/451

(57) ABSTRACT

A replaceable screw fastening assembly has a socket, a bit and an elastic ring. The socket has an abutting end, an inner hole and an annular groove. The inner hole is formed through the socket and has an internal surface. The annular groove is formed in the internal surface of the inner hole. The bit is detachably connected to the socket in the inner hole and has an external surface, an operating segment, a connecting segment ad a ring recess. The operating segment extends out of the abutting end of the socket. The connecting segment extends out of a bottom of the socket. The ring recess is formed around the external surface of the bit between the ends. The elastic ring is mounted around the ring recess of the bit in the annular groove of the socket to hold the bit securely with the socket.

### BACKGROUND OF THE INVENTION

1. Field of the Invention

The present invention relates to a fastening assembly, especially to a replaceable screw-fastening assembly that is replaceable with different kinds of bits.

2. Description of the Prior Arts

A conventional fastening assembly has a socket and a bit to loosen or fasten a screw. The socket is hollow and has an end abutting with a surface of a work piece, such as a wood to provide a holding effect to the conventional fastening assembly when rotating the screw. The bit is formed with the socket and has a connecting segment and an operating segment. The connecting segment of the bit is formed with the socket. The operating segment of the bit extends out of the socket and is connected to the screw.

However, the socket and the bit of the conventional fastening assembly are made as a single piece and have a specific size. Therefore, the conventional fastening assembly can not be applied to screws in different sizes and is not versatile in use. The user must prepare multiple fastening assemblies in different sizes to fit with screws in different sizes and this is costly.

In addition, another conventional fastening assembly has a flexible and hollow body and a bit connected to the body. The body has a limiting recess formed in the body and corresponding to the shape of the head of a screw and a mounting recess formed in the body. The bit has two ends, a connecting segment, an engaging segment and an extending segment. One of the ends of the bit is connected to the head of the screw and the other end is connected to a power tool. Each segment of the bit has a diameter. Although the body of the conventional fastening assembly can be replaced from the bit, the diameters of the segments of the bit are different and the body can not tightly mounted around the bit. After several times of assembling and disassembling the body and the bit, the body may suffer elastic fatigue and this will shorten the life of the conventional fastening assembly.

To overcome the shortcomings, the present invention provides a replaceable screw-fastening assembly to mitigate or obviate the aforementioned problems.

### SUMMARY OF THE INVENTION

The main objective of the present invention is to provide a replaceable screw fastening assembly that can replace the kinds of the bits in use.

The replaceable screw fastening assembly in accordance with the present invention has a socket, a bit and an elastic ring. The socket has an abutting end, an inner hole and an annular groove. The inner hole is formed through the socket and has an internal surface. The annular groove is formed in the internal surface of the inner hole. The bit is detachably connected to the socket in the inner hole and has an external surface, an operating segment, a connecting segment ad a ring recess. The operating segment of the bit extends out of the abutting end of the socket. The connecting segment of the bit extends out of a bottom of the socket. The ring recess is formed around the external surface of the bit between the ends and communicates with the annular groove of the socket. The elastic ring is mounted around the ring recess of the bit in the annular groove of the socket to hold the bit securely with the socket.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a replaceable screw-fastening assembly in accordance with the present invention;

FIG. 2 is an exploded perspective view of the replaceable screw-fastening assembly in FIG. 1;

FIG. 3 is a cross sectional side view of the replaceable screw-fastening assembly in FIG. 1;

FIG. 4 is a cross sectional top view of the replaceable screw-fastening assembly along line 4-4 in FIG. 3;

FIG. 5 is a side view in partial section of a second embodiment of a replaceable screw-fastening assembly in accordance with the present invention;

FIG. 6 is a side view in partial section of a third embodiment of a replaceable screw-fastening assembly in accordance with the present invention;

FIG. 7 is a side view in partial section of a fourth embodiment of a replaceable screw-fastening assembly in accordance with the present invention; and

FIG. 8 is an operational side view of the replaceable screw-fastening assembly in FIG. 1 connected to a power tool and a screw.

### DETAILED DESCRIPTION OF PREFERRED EMBODIMENTS

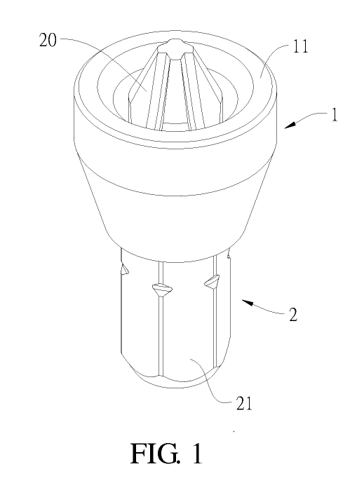

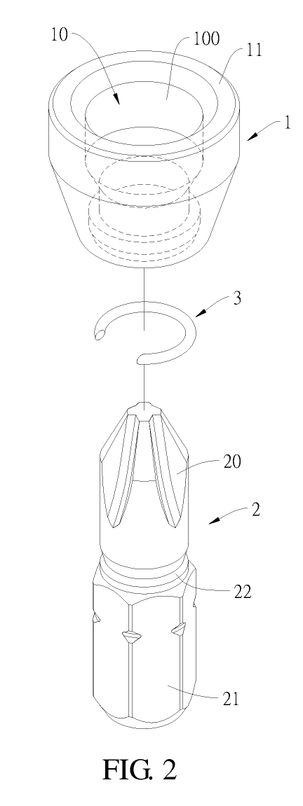

With reference to FIGS. 1 to 5, a replaceable screw fastening assembly in accordance with the present invention has a socket 1, a bit 2 and an elastic ring 3.

The socket 1 is hollow and has a top, a bottom, an abutting end 11, an inner hole 10 and an annular groove 12.

The abutting end 11 is formed on the top of the socket 1.

The inner hole 10 is formed through the top and the bottom of the socket 1 and has an internal surface, a diameter and an enlarged segment 100 formed in the internal surface of the inner hole 10 adjacent to the abutting end 11.

The annular groove 12 is formed in the internal surface of the inner hole 10 near the bottom of the socket 1.

The bit 2 is detachably connected to the socket 1 in the inner hole 10 and has two ends, an external surface, an operating segment 20, a connecting segment 21 ad a ring recess 22.

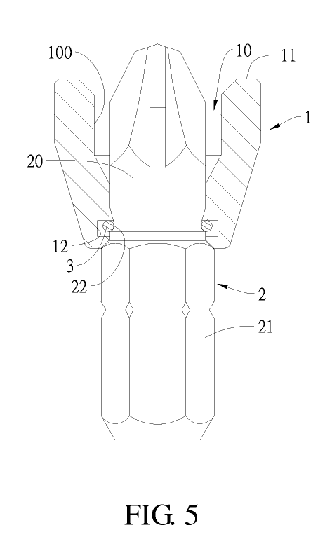

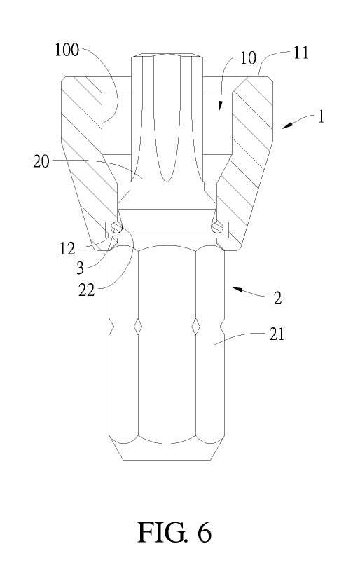

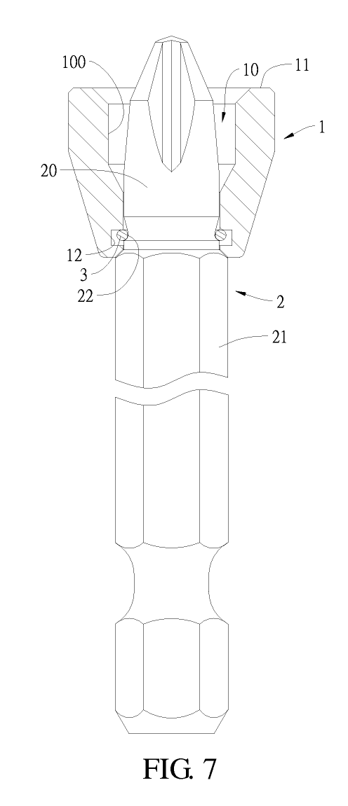

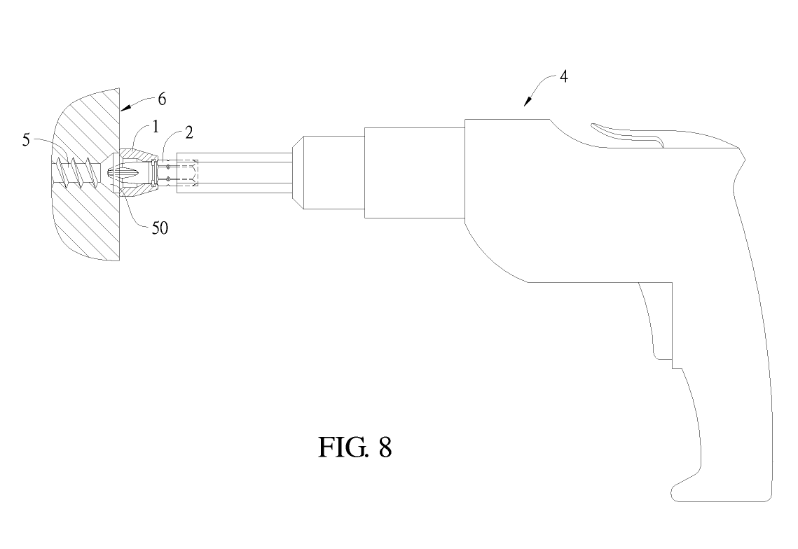

The operating segment 20 is defined in one of the ends of the bit 2 and extends out of the abutting end 11 of the socket 1. With reference to FIGS. 5 to 8, the operating segment 20 of the bit 2 is connected to a head 50 of a screw 5 and may be cross-shaped, in-line shaped or polygonal.

The connecting segment 21 may be polygonal, is defined in the other end of the bit 2 opposite to the operating segment 20 and extends out of the bottom of the socket 1. With further reference to FIG. 8, the connecting segment 21 of the bit 2 is connected to a power tool 4 and has a diameter larger than the diameter of the inner hole 10 of the socket 1.

The ring recess 22 is formed around the external surface of the bit 2 between the operating segment 20 and the connecting segment 21 and aligns with the annular groove 12 of the socket 1.

The elastic ring 3 may be a C-shaped ring, is mounted in the ring recess 22 of the bit 2 and the annular groove 12 of the socket 1 to hold the bit 2 securely with the socket 1.

The socket 1 and the bit 2 of the replaceable screw-fastening assembly in accordance with the present invention can be made of metal or alloy.

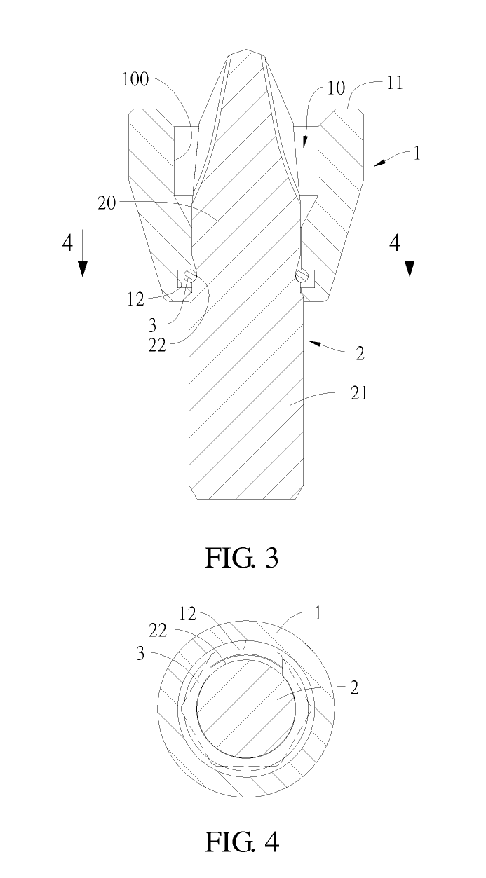

With reference to FIGS. 3 and 4, to combine the bit 2 with the socket 1, the elastic ring 3 is pressed and deformed to mount into the annular groove 12.

With the elastic ring 3 being mounted in the annular groove 12, the bit 2 is inserted into the inner hole 10 via the bottom of the socket 1 and is held by the elastic ring 3. Thus, the bit 2 can be held securely with the socket 1 by the elastic ring 3. Furthermore, with reference to FIGS. 5 to 7, bits 2 in different shapes or lengths can be inserted in the inner hole 10 of the socket 1 to allow the single socket connecting with different kinds of bits. To replace a bit 2, the previous bit 2 is pulled out of the inner hole 10 from the bottom of the socket 1 and is separated from the elastic ring 3, and the elastic ring 3 is kept in the socket 1. Consequently, another kind of bit 2 can be inserted into the socket 1 and held by the elastic ring 3 for different working needs.

In use, with reference to FIG. 8, the connecting segment 21 of the bit 2 is mounted securely in a rotating end of a power tool 4 and the operating segment 20 of the bit 2 is connected to a head 50 of a screw 5, the head 50 of the screw abuts with the abutting end 11 of the socket 1. After moving a tip of the screw 5 to contact with a surface of a wood 6, the power tool 4 is started. Then, the connecting segment 21 of the bit 2 is rotated with the rotating end of the power tool 4 and the tip of the screw 5 is rotated into the wood 6. After using the replaceable screw fastening assembly to fasten the screw 5 by the power tool 4, the head 50 of the screw 5 can be mounted close to the surface of the wood and this can provide an artistic and safety wood work piece.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A replaceable screw-fastening assembly comprising
a socket having
a top;
a bottom;
an abutting end formed on the top of the socket;
an inner hole formed through the top and the bottom of the socket and having an internal surface; and
an annular groove formed in the internal surface of the inner hole near the bottom of the socket;
a bit detachably connected to the socket in the inner hole and having
two ends;
an external surface;
an operating segment defined in one of the ends of the bit and extending out of the abutting end of the socket;
a connecting segment defined in the other end of the bit opposite to the operating segment and extending out of the bottom of the socket; and
a ring recess formed around the external surface of the bit between the operating segment and the connecting segment and communicating with the annular groove of the socket; and
an elastic ring mounted around the ring recess of the bit in the annular groove of the socket to hold the bit securely with the socket.

2. The replaceable screw fastening assembly as claimed in claim 1, wherein the inner hole of the socket has a concave segment formed in the internal surface of the inner hole adjacent to the abutting end.

3. The replaceable screw fastening assembly as claimed in claim 2, wherein
the inner hole of the socket has a diameter; and
the connecting segment of the bit has a diameter larger than the diameter of the inner hole of the socket.

4. The replaceable screw fastening assembly as claimed in claim 3, wherein the elastic ring is a C-shaped ring.

5. The replaceable screw fastening assembly as claimed in claim 1, wherein
the inner hole of the socket has a diameter; and
the connecting segment of the bit has a diameter larger than the diameter of the inner hole of the socket.

6. The replaceable screw fastening assembly as claimed in claim 1, wherein the elastic ring is a C-shaped ring.

7. The replaceable screw fastening assembly as claimed in claim 2, wherein the elastic ring is a C-shaped ring.
